(19) United States
(12) Patent Application Publication
(10) Pub. No.: US 2011/0082678 A1
(43) Pub. Date: Apr. 7, 2011

(54) METHOD OF OPTIMIZING THE INJECTION OF A REACTIVE FLUID INTO A POROUS MEDIUM

(76) Inventors: Lionnel ALGIVE, Rueil Malmaison (FR); Samir Bekri, Rueil Malmaison (FR); Olga Vizika, Rueil Malmaison (FR)

(21) Appl. No.: 12/889,742

(22) Filed: Sep. 24, 2010

(30) Foreign Application Priority Data
Oct. 1, 2009 (FR) 09/04682

(51) Int. Cl. G06G 7/58

(52) U.S. Cl. 703/12

(57) ABSTRACT

The invention is a method of optimizing the injection of a fluid into a porous medium, using modelling the migration of the fluid within the medium having application for oil reservoir development. A reservoir model is constructed. In each cell of this the model, a PNM model representative of the pore network in the cell is constructed. The concentration of the fluid is then determined in each cell by solving the cell-scale reactive transport equation. Fluid concentration modifications at the level of the fluid/rock interface, at the pore scale, are therefore taken into account by means of the PNM models. Corrective coefficients for the reactive transport equation and a law between the permeability of the porous medium and the porosity of the porous medium are thus calculated. Finally, fluid injection is optimized as a function of the concentrations in each cell.

### BACKGROUND OF THE INVENTION

1. Field of the Invention

The present invention relates to the field of underground porous media development, and notably to the geological storage of carbon dioxide or enhanced hydrocarbon recovery through CO₂ injection.

2. Description of the Background Art

Geological storage is considered for reducing the anthropic emission of carbon dioxide which is a greenhouse gas. Carbon dioxide gas is a reactive fluid within the porous medium. Its dissolution in water causes acidification thereof. This perturbation of the initial thermodynamic equilibrium causes a modification in the rock structure by dissolving and/or precipitating minerals. By thus changing the pore size distribution of the porous medium, the CO₂ impacts the petrophysical properties of the rock, notably the porosity and the permeability. Other properties such as the capillary pressure and the relative permeabilities can also be affected. The wettability of the new mineral at the rock/fluid interface can be different from the initial state.

For the aforementioned reasons, and in order to predict the migration of CO₂ within the reservoir, operators require softwares referred to as “numerical simulators” that can account for reactive flows. The quality of these simulations is invaluable for predicting possible injectivity losses, mechanical weakening, channelling creation and/or effects on cap rock integrity. Depending on the result of these simulations, the decision to use or not use a reservoir for CO₂ storage is made. The amounts of CO₂ that can be injected and the optimum injection flow rate are also assessed.

Softwares allowing the flow of a fluid and/or the transport of a species to be simulated at the scale of a reservoir are known. These softwares are referred to as “flow simulators”. Flow simulation solves Darcy's equation to determine the velocity of the fluid. Simulating the reactive transport of a species solves the macroscopic reactive transport equation in order to determine the concentration of the fluid, or at least a species contained in this fluid. In practice, a grid of the porous medium is used by the software to simulate a three-dimensional and three-phase flow of several components. The software calculates the velocity of the fluid (CO₂) at the interfaces of the grid cells and, in each cell, the concentration of at least one species (CO₂), assumed to be homogeneous on this volume. The molar conservation equations are solved via a totally coupled system, linearized by a Newtonian approach.

The macroscopic reactive transport equation is written as follows for a 1 order kinetics:

$$\frac{\partial \overline{c}}{\partial t} + ∇ \cdot ( {\overline{v}}^{*} \overline{c} - {\overline{D}}^{*} \cdot ∇ \overline{c} ) + {\overline{γ}}^{*} ( \overline{c} - {c}^{*} ) = 0$$

where:

c̅ is the mean concentration of the chemical species studied;

c* is the equilibrium concentration;

γ̅* is the mean apparent velocity of the reaction; and

v̅* is the mean velocity of the solute; and

D̅* is the mean dispersive tensor of the solute.

The explanation of this formula can be found in the following article:
Shapiro M., Brenner H., Dispersion of a Chemically Reactive Solute in a Spatially Model of a Porous Medium, Chemical Engineering Science, 1988, 43, p. 551-571.

The simulation of the flows allows determination of the mean velocity v̅* of the solute and the mean dispersive tensor D̅* of the solute.

The mean apparent velocity γ̅* of the reaction and the equilibrium concentration c*are determined by software referred to as a “geochemical module”. This type of software allows accounting for the creation or the consumption of species due to the reactions involved in these equations. Some flow simulators directly integrate a geochemical module such as, for example, the COORES® simulator (IFP, France). A description of such simulators is provided in the following documents:
Le Gallo, Y. et al., “Long-Term Flow Simulation of CO2 Storage in Saline Aquifer” Proceedings of the 8th Conference on GreenHouse Gas Technologies, IEA, Trondheim, Norway, 2006.
Trenty, L., et al., “A Sequential Splitting Strategy for CO2 Storage Modelling”. Proceedings of 10th European Conference on the Mathematics of Oil Recovery, EAGE, Amsterdam, The Netherlands, 2006.

A geochemical module is based on the concept of the perfect mixer (OD model). It calculates, for a system assumed to be closed, the equilibrium concentration of each species (solid, dissolved or gaseous), and the evolution of their concentration over time by thermodynamic (reaction constants, enthalpy, etc.) and kinetic (reaction velocities, activation energy, etc.) data.

However, such a model is based on the equilibrium study from mean concentrations, whereas it is the concentrations at the rock/fluid interface that are in fact involved during surface dissolution/precipitation reactions. In order to account for this difference, an empirical corrective, sometimes referred to as “reaction efficiency”, is generally introduced.

Similarly, the transport parameters involved in the macroscopic convection-dispersion equation are impacted by the presence of surface reactions. In fact, this equation is a function of the velocity and of the dispersion of the solute, which differ from those a priori known for the fluid in case of reaction at the surface. This is due to the fact that the concentration profile at the pore scale is no longer uniform. Thus, as for the source term, corrective terms relative to the velocity, the dispersion and the apparent reaction are introduced in the conventional transport equation developed for an inert tracer. These corrective terms are referred to as“transport proportionality coefficients”.

Thus, within reactive flow simulators, the macroscopic reactive transport equation is generally written by the conventional equation to which correctives, the proportionality coefficients, are added:

$$\frac{\partial \overline{c}}{\partial t} + ∇ \cdot ( {\overline{v}}^{′} \overline{v} \overline{c} - {\overline{D}}^{′} \overline{D} \cdot ∇ \overline{c} ) + {\overline{γ}}^{′} \overline{γ} \cdot ( \overline{c} - {c}^{*} ) = 0$$

$${\overline{v}}^{*} = {\overline{v}}^{′} \cdot \overline{v} {\overline{D}}^{*} = {\overline{D}}^{′} \cdot \overline{D} {\overline{γ}}^{*} = {\overline{γ}}^{′} \cdot \overline{γ}$$

where:

γ̅ is the estimated reaction kinetics within the scope of the perfect mixer;

v̅ is the mean velocity of the fluid;

D̅ is the conventional dispersive tensor; and

v̅′, D̅′ and γ̅′ are the proportionality coefficients of the reactive transport.

FIG. 2a describes the conventional method for solving the reactive transport equation within the scope of porous media.

A set of data relative to the porous medium and to the fluids present in this medium is first acquired. Data relative to the fluid (DF), such as the molecular diffusion coefficient D, density ρ or viscosity μ, are acquired. Data relative to the mineralogy of the medium (DM), such as density ρ, the intrinsic reaction velocity κ and the mineral solubility product Kₛ, are acquired. Finally, properties relative to the medium, such as permeability K, porosity φ or lithologic facies FL, are acquired. A reservoir model (MR) is then constructed. That is a discretization of the porous medium in the form of a grid wherein each cell contains properties relative to the porous medium and to the fluid present in this medium is constructed.

A simulation of the flows within the reservoir model is then carried out, by a reactive flow simulator (SER) supplied with the data relative to the fluid as input data. These flow simulations (SEC) allow determination of the mean velocity v̅ of the fluid and the mean dispersive tensor D̅ of the solute.

Transport proportionality coefficients (CPT) are empirically determined: γ̅′, v̅′, D̅′.

In parallel, from the reservoir model and the mineralogic data (DM), a geochemical module (MG) is used to determine:
an estimation of the reactive surface (σ);
the mean apparent reaction velocity ( γ̅), from the reactive surface (σ) wherein the mineralogic data and a mean concentration c̅ of the chemical species studied, the concentration is deduced from the transport equation, which itself depends on the source term and there is therefore a coupling (CPL) between the geochemical module (MG) and the reactive flow simulator; and
finally, a porosity variation δφ as a function of time t is estimated as a function of the mean apparent reaction velocity ( γ̅) and of the transport proportionality coefficient associated with this velocity, denoted by γ̅′.

A permeability variation δK is determined from this porosity variation δφ and Kzeny-Carman's empirical law (KC).

This permeability variation δK, the transport proportionality coefficients (CPT) and the mean apparent reaction velocity ( γ̅) are supplied to the reactive flow simulator (SER) to solve the transport equation. The result is the mean concentration c̅ of the chemical species being studied. This concentration is used by the geochemical module (MG) via coupling (CPL).

The usual method iterates, according to a time loop (BT), between these two modules according to more or less sophisticated schemes until their simultaneous convergence is reached. Then, for this concentration field, the amount of minerals precipitated or dissolved is calculated by the geochemical module. This amount is empirically related to a permeability variation (Kozeny-Carman's relation for example). Knowledge of the permeability is in fact necessary to determine the velocity field at the next time iteration. Then all that is necessary is to reiterate with this new flow as many times as is desired.

The transport proportionality coefficients (CPT) depend on the flow and reaction regimes. They account for the local specific features of the reactive transport (non-uniformity of the concentration profile) when the precipitation and dissolution phenomena are studied on a global scale. Due to this fundamental interaction between the two scales, it appears that sizeable imprecisions within the numerical simulations can be obtained if the transport proportionality coefficients are badly assessed. However, through lack of adequate information, these coefficients are currently deduced from some empirical relations or, failing that, totally omitted (proportionality coefficients equal to 1). They can also be determined by solving the associated eigenvalue problem. This technique, coming from the theory of moments, is described in the aforementioned paper by Shapiro and Brenner. However, semi-analytical solutions are available only for basic geometries such as the circular cylinder or parallel plates.

### SUMMARY OF THE INVENTION

The invention is an alternative method of optimizing the injection of a fluid into a porous medium, notably a reactive fluid. The method allows monitoring of the migration of the reactive fluid in the porous medium by a simulation of the reactive transport of the reactive fluid within this medium. The invention overcomes the problems of the prior art by accounting for the chemical reactions and the flow modes at the scale of the pore of the porous medium. The method is therefore based on a PNM pore network model for determining laws relating permeability and porosity, and proportionality coefficients that account for these two parameters.

The invention relates to a method of optimizing the injection of a fluid into a porous medium comprising a pore network, from a discretization of the porous medium into a set of grid cells. According to the method, the migration of the fluid within the porous medium is modelled by determining in each cell the concentration of a chemical species involved in a chemical reaction between the fluid and the medium, by solving a cell-scale reactive transport equation. The method comprises the following:
solving the equation by accounting for modifications in the concentrations of the chemical species at the pore scale, by a representation of the pore network for each cell by a PNM model; and
optimizing the injection of the fluid into the porous medium, as a function of the concentrations in each cell.

It is possible to account for the concentration modifications at the pore scale by modifying structurally the PNM model in each cell. According to the invention, the equation can be solved by carrying out the following:
i. Constructing a representation of the pore network for each cell, by a PNM model comprising a set of nodes of known geometry connected by channels of known geometry;
ii. Defining the cell-scale reactive transport equation by relating concentration c̅ to three parameters, a mean velocity of the species v̅, a mean dispersive tensor of the species D̅ and a mean reaction apparent velocity on a cell γ̅ with each parameter being weighted by a cell-scale transport proportionality coefficient v̅′, D̅′ and γ̅′;
iii. Determining coefficients v̅′, D̅′ and γ̅′ by means of the PNM model;
iv. Account for structural modifications of the pore network generated through chemical reaction, by modifying the PNM model and by deducing petrophysical properties from this modified PNM model;

v. Solving the equation from coefficients v̅′, D̅′ and γ̅′, the petrophysical properties, and measurements relative to the medium and to the fluid.

The following can be carried out to determine the cell-scale proportionality coefficients v̅′, D̅′ and γ̅′:
a. Determining pore-scale transport proportionality coefficients v̅′, D̅′ and γ̅′, in each channel and node of the PNM model;
b. Determining a species concentration in each channel and node of the PNM model by solving a pore-scale reactive transport equation, from the pore-scale transport proportionality coefficients v̅′, D̅′ and γ̅′; and
c. Deducing from the results of a and b above the cell-scale transport proportionality coefficients v̅′, D̅′ and γ̅′ by a homogenization method.

According to an embodiment, the cell-scale reactive transport equation is written as follows:

$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$

where c* is an equilibrium concentration of the species.

The pore-scale transport proportionality coefficients v̅′, D̅′ and γ̅′ can be defined as a function of the spatial moments of the species. They can then be determined by determining the spatial moments as a function of a technique of moments or of a random walk technique. The pore-scale transport proportionality coefficients v̅′, D̅′ and γ̅′ can also be defined as follows:

$$f ( PeDa ) = 1 + \frac{a}{{( 1 + \frac{b}{{( PeDa )}^{α}} )}^{β}} where f = {\overline{γ}}^{′} o r {\overline{v}}^{′} or {\overline{D}}^{′}$$

and where PeDa is the Péclet-Damköhler number, and a, b, α and β are parameters defined as a function of the geometry of the PNM model.

According to the invention, the PNM model can be modified to account for the structural pore network modifications generated through chemical reaction by determining a chemical species concentration at the walls of each node and channel, and by deducing therefrom a variation in the geometry of the nodes and channels of the PNM model.

The measurements used to solve the equation can comprise at least the following measurements:
measurements relative to the fluid, such as: molecular diffusion coefficient, density and viscosity; and
measurements relative to the medium, such as: permeability, porosity, lithological facies, density and intrinsic reaction velocity.

Finally, according to an embodiment, the fluid is CO₂, and CO₂ injection into the porous medium is optimized by carrying out at least one of the following operations:
modifying an amount of CO₂ injected into the medium;
modifying a CO₂ injection flow rate;
drilling new holes in the medium to inject CO₂;
setting at least one remediation device in the medium to remedy CO₂ leaking to the surface or an aquifer; and
adding additives to the CO₂ injected.

### BRIEF DESCRIPTION OF THE DRAWINGS

Other features and advantages of the method according to the invention will be clear from reading the description hereafter of embodiments given by way of non limitative examples, with reference to the accompanying figures wherein:

FIG. 1 shows a diagram of a pore network and of its unit cell;

FIG. 2a illustrates the various stages of solving the reactive transport equation according to prior methods;

FIG. 2b illustrates the various stages of solving the reactive transport equation according to the invention;

FIG. 3 shows, as a function of the Péclet-Damköhler number, the three proportionality coefficients of the macroscopic reactive transport equation for three geometries conventionally used in the conceptualization of the pore network wherein the symbols are the values obtained via the random walk method, and the continuous line, and the generic function used to analytically express these coefficients and the generic function facilitates the subsequent use of the proportionality coefficients in the PNM model;

FIG. 4 shows, as a function of the Péclet-Damköhler number, the three transport proportionality coefficients at the scale of the core (entire network) for a uniform pore size distribution wherein the coefficients depend on the flow (Péclet number); and

FIG. 5 shows permeability/porosity relations obtained for a single rock, depending on the reactive flow regime.

### DETAILED DESCRIPTION OF THE INVENTION

The invention relates to a method for developing an underground porous medium by injecting a fluid, notably a reactive fluid, therein. The method allows monitoring of the migration of the reactive fluid in the porous medium, by a simulation of the reactive transport of the reactive fluid within the medium.

According to an embodiment, the reactive fluid is CO₂. It generally dissolves within the porous medium in liquid water or brine. Studying the migration of the CO₂ injected amounts to studying the flow of the brine while accounting for the chemical reactions of the solute made up of CO₂.

In this context, the method determines the CO₂ concentration at any point of the medium. It is also possible to determine the concentration of other chemical species involved in a chemical reaction between the fluid and the medium, such as ions or molecules (CaCO₃, Ca²⁺, CO₂, CO₃², . . . ).

The goal is to acquire data relative to the porous medium and to the reactive fluid (dissolved CO₂), to construct a reservoir model discretizing the porous medium, to solve the reactive transport equation to determine the dissolved CO₂ concentrations, in each cell of the reservoir model, so as to monitor the movements of the dissolved CO₂ and other chemical species in the medium. Finally, from this information, the development of the medium can be modified by drilling of new holes, injection pressure modification, setting of remediation devices, addition of additives to the CO₂, etc.

The method thus comprises four main stages:
1. Acquiring data relative to the porous medium and to the reactive fluid (dissolved CO₂);
2. Constructing a reservoir model discretizing the porous medium;
3. Determining the concentrations of the dissolved CO₂ and of other chemical species in each cell of the model; and
4. Optimizing CO₂ injection into the porous medium.

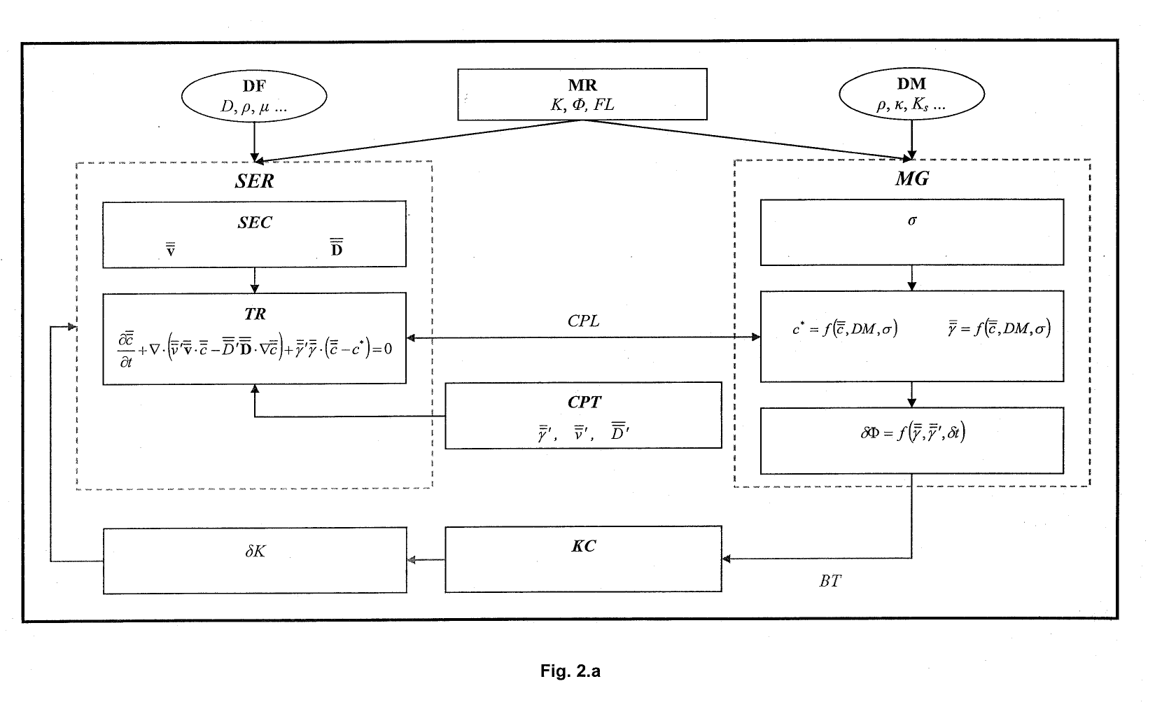

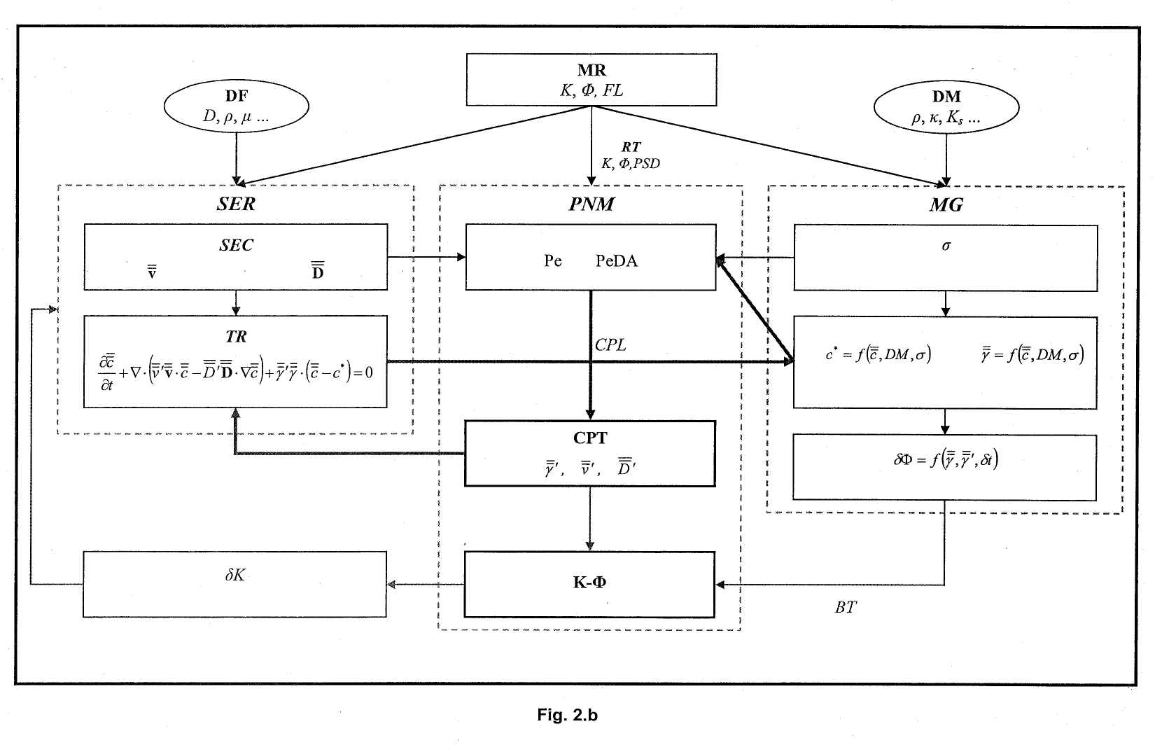

FIG. 2b describes the first three stages of the method according to the invention.

1. Acquisition of Data Relative to the Porous Medium and to the Fluid

A set of data relative to the porous medium and to the fluids present in this medium is first acquired. Data relative to the fluid (DF), such as the molecular diffusion coefficient D, density ρ or viscosity μ, are acquired.

Data relative to the mineralogy of the medium (DM), such as density ρ, the intrinsic reaction velocity κ and the mineral solubility product Kₛ, are also acquired.

A classification of the rocks of the medium, referred to as a “rock type” (RT), is also carried out. It groups together lithological facies to form groups having common properties, such as permeability, porosity or pore size distribution (PSD).

Finally, properties relative to the medium, such as permeability K, porosity φ or lithological facies FL, are acquired.

2. Constructing a Reservoir Model Discretizing the Porous Medium

A reservoir model (MR) is constructed which is a discretization of the porous medium in the form of a grid, wherein each cell contains properties relative to the porous medium and to the fluid present in this medium.

3. Determining Dissolved CO₂ Concentrations in Each Cell of the Model

In order to determine the concentration of dissolved CO₂ and/or other chemical species in each cell of the model, the reactive transport equation is solved:

$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$

with:

c̅ the concentration of the chemical species being studied averaged on a cell of the reservoir model;

v̅ being the velocity of the solute averaged on a cell of the reservoir model;

D̅ is a solute dispersive tensor averaged on a cell of the reservoir model;

c′ is an equilibrium concentration of the chemical species being studied;

γ̅ is the reaction apparent velocity averaged on a cell of the reservoir model; and

v̅′, D̅′ and γ̅′ are transport proportionality coefficients for a cell of the reservoir model.

According to the invention, this equation is solved. That is c̅ is determined in each cell of the reservoir model by a time loop, based on a coupling (CPL) between a reactive flow simulator (SER), a geochemical module (MG) and a pore network model (PNM). FIG. 2b illustrates this coupling.

In order to increase the reliability of these simulations and thus to optimize CO₂ injections, the present invention provides a method based on the pore network approach that supplies a “reactive flow simulator” with data specific to reactive flows. This data set, which is based on a physical modelling of the rock/fluid interactions at the pore scale, can greatly increase the quality of the simulations. The invention allows physically obtaining these coefficients by solving the pore-scale transport problem and then by deducing therefrom the macroscopic parameters corresponding to the core scale. The structure of the porous medium is considered. This technique also allows relating the porosity variation, due to the precipitations and dissolutions, to a correct permeability evolution. In fact, from the pore network approach, physical permeability/porosity laws can be obtained. They are more reliable than the current empirical relations such as the Kozeny-Carman relation.

A simulation of the flows within the reservoir model is carried out by a reactive flow simulator (SER) to which the data relative to the fluid are supplied as input data. These flow simulations (SEC) allow determination of the mean velocity v̅ of the solute and the mean dispersive tensor v̅ of the solute.

In parallel, from the reservoir model and the mineralogic data (DM), a geochemical module (MG) is used to determine:
an estimation of the reactive surface (σ);
the mean apparent reaction velocity ( γ̅) and the equilibrium concentration c* of the chemical species being studied, from the reactive surface (σ), mineralogic data and a mean concentration c̅ of the chemical species studied wherein the concentration is deduced from the transport equation, which itself depends on the source term and therefore a coupling (CPL) between the geochemical module (MG) and the reactive flow simulator; and
finally, a porosity variation δφ as a function of time t which is estimated as a function of the mean apparent reaction velocity ( γ̅) and of the transport proportionality coefficient associated with the velocity, denoted by γ̅′.

The equilibrium concentration and the reaction kinetics are not exogenous parameters and depend on all the species involved in the chemical system being studied. They are generally calculated by a geochemical module that assumes, for the solution thereof, a closed system. This is the reason why, in the presence of yields due to the transport, the simulators have to iterate until simultaneous convergence of the transport and geochemistry modules is reached. In this approach, these parameters are considered to be known and constant (within the context of the reactive transport module).

The transport proportionality coefficients (CPT): v̅′, D̅′ and γ̅′ remain to be determined in order to solve the macroscopic reactive transport equation.

According to the invention, these coefficients are determined by a pore network model, referred to as PNM model, and by carrying out the following:

a. Constructing a pore network model PNM for each cell of the reservoir model;

b. Determining the pore-scale transport proportionality coefficients;

c. Solving the macroscopic pore-scale reactive transport equation;

d. Deducing therefrom the transport proportionality coefficients at the scale of the cell of the reservoir model;

e. Modifying the structure of the network and deducing therefrom new petrophysical properties; and

f. Determining the CO₂ concentrations in each cell of the model.

a. Constructing Pore Network Models PNM

The invention is based on a pore network model. Such an approach is in fact an efficient tool for considering phenomena that occur at the pore scale.

A known type of representation referred to as “Pore Network Modelling” (PNM), is therefore used. A detailed description of pore network modelling technique (PNM) in terms of approach, model characteristics and construction is presented in the following document:
Laroche, C. and Vizika, O., “Two-Phase Flow Properties Prediction from Small-Scale Data Using Pore-Network Modelling”, Transport in Porous Media, (2005), 61, 1, 77-91.

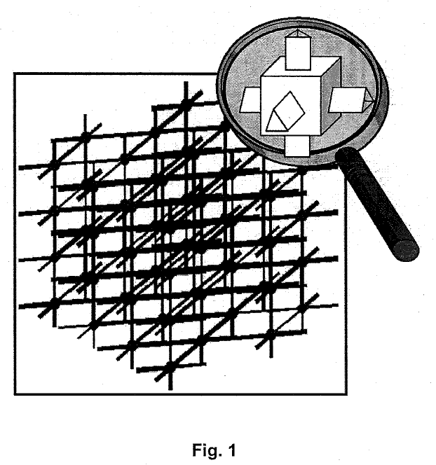

This pore network model is a conceptual representation of a porous medium, whose goal is to account for flow physics and transport phenomena, without showing the real structure of the network of the pores of the porous medium (rock). The structure is modelled by a three-dimensional pore network, making up the nodes, interconnected by channels, representing the links between the pores. Although it does not describe the exact morphology of the porous medium, such a model can account for the essential topology and morphology characteristics of the porous space. A real porous medium comprises angulosities and recesses that favour the flow of the wetting fluid, even when the center of the channel or of the pore is filled by a non-wetting fluid. In order to account for this fact, which influences recovery, angular sections are preferably considered for the pores and the channels. The pore network is thus represented by a three-dimensional cubic matrix of pores interconnected by channels, and having generally a coordination number of six (but it can be variable), which means that 6 channels are connected to each pore. A node (N) and its channels (C) make up what is referred to as a unit cell of the network model, as illustrated in FIG. 1.

Mercury invasion experiments (“mercury porosimetry”) have to be carried out in the laboratory to construct such a model. This well-known technique, allows allows determination of the threshold size distributions, represented by the channels in the network model (PNM).

From this distribution, the pore size distribution (PSD) represented by spheres or cubes in the network model (PNM) (FIG. 1) is determined. A correlation between the pores and their adjacent channels is therefore considered. An aspect ratio (AR) relating pore diameter dₚ to channel diameter d_{c} is then fixed. During construction of the network, the diameters of the channels are randomly assigned in accordance with the experimental distribution obtained by mercury porosimetry. It should be noted that, in the case of a triangular section, the diameter corresponds to that of the circle inscribed in the triangle under consideration.

This approach had initially been developed in order to study multiphase flows, where the concentration could be considered as uniform at the pore scale. However, this hypothesis is no longer valid in the case of dissolved species such as the acids generated by dissolution of CO₂ in water. In fact, the local concentration profile and the porous structure changes must be taken into account when solving the equations. Thus, according to the invention, the usual PNM pore network approach is modified to account for these constraints.

Using a PNM model allows the effects of the topology (connection, tortuosity, etc.) on the homogenized macroscopic parameters to be taken into account.

A PNM model is thus constructed for each cell of the reservoir model.

b. Determining Pore-Scale Transport Proportionality Coefficients

This stage determines transport proportionality coefficients v̅′, D̅′ and γ̅′ for each element of the pore network: each pore and each channel. These pores and these channels are represented by simple geometric elements: circular, triangular or elliptical capillary for the first ones, sphere or cube for the second (FIG. 1).

The pore network approach uses no continuous local equations such as the Navier-Stokes equation, and uses a macroscopic equation with a solution averaged from previous solution for simple constituent geometries of the network (Poiseuille's law for example). This then allows performing simulations on a larger number of pores which therefore are likely to constitute a Representative Elementary Volume. Within the context of reactive transport, it is desirable to determine the mean concentration of each pore c̅ verifying the macroscopic transport equation reminded below:

$$\frac{\partial \overline{c}}{\partial t} + ∇ \cdot ( {\overline{v}}^{′} \overline{v} \overline{c} - {\overline{D}}^{′} \overline{D} \cdot ∇ \overline{c} ) + {\overline{γ}}^{′} \overline{γ} \cdot ( \overline{c} - {c}^{*} ) = 0$$

The following formulas, which give the long-time proportionality coefficients (asymptotic regime) as a function of the spatial moments mᵢ(t) of the solute, are therefore used. It should be noted that a spatial moment is the integration, on the volume considered, of the concentration weighted by a power of the position vector. If this power is zero, the amount present in the medium is then calculated. The moments of order 1 and 2 are used to calculate the barycenter, i.e. the center of gravity, and the standard deviation, that is the spread in relation to this center. These formulas are for example described in Shapiro M., Brenner H., “Taylor Dispersion of Chemically Reactive Species: Irreversible First-Order Reactions in Bulk and on Boundaries”, Chemical Engineering Science, 1986, 41, n° 6, p. 1417-1433.

$${\overline{γ}}^{′} = - \frac{1}{{m}_{0}} \frac{d {m}_{0}}{d t}$$

$${\overline{v}}^{′} = \frac{d}{d t} ( \frac{{m}_{1}}{{m}_{0}} ) = \frac{1}{{m}_{0}} [ \frac{d {m}_{1}}{d t} + {\overline{γ}}^{′} {m}_{1} ]$$

$${\overline{D}}^{′} = \frac{d}{d t} ( \frac{{m}_{2}}{{m}_{0}} - {( \frac{{m}_{1}}{{m}_{0}} )}^{2} ) = \frac{1}{{m}_{0}} [ \frac{d {m}_{2}}{d t} - ( {\overline{v}}^{′} {m}_{1} + {m}_{1} {\overline{v}}^{′} ) + {\overline{γ}}^{′} {m}_{2} ] \\ where {m}_{i} ( t ) = \int c ( r , t ) {r}^{i} d r .$$

Each coefficient is then determined by calculating the spatial moments. Therefore, either the technique of moments and the solution of the eigenvalue problem is applied if there is an analytical solution, or the random walk technique is used to study the propagation of a cluster of reactive particles.

### The Technique of Moments: Analytical Calculation of the Spatial Moments of the Solute

This technique is only used for two-dimensional geometries (parallel plates, cylinder, etc.). It is described in the following document:
Shapiro M., Brenner H., “Taylor Dispersion of Chemically Reactive Species: Irreversible First-Order Reactions in Bulk and on Boundaries”, Chemical Engineering Science, 1986, 41, n° 6, p. 1417-1433.

The technique of moments expresses the moments mᵢ by solving the corresponding eigenvalue problem that is a function of the local transport data, which allows ending the scale change (local scale to mean scale of the pores).

### The Random Walk Technique: Numerical Calculation of the Spatial Moments of the Solute

For a triangular or elliptical capillary, the three spatial variables of the solute particle are necessary for characterizing unambiguously its transport and flow properties. In this case, the solution can only be numerical and the random walk, which is easy to implement, is desired. A random walk is the result of a stochastic (random) diffusive displacement. By extension, what is referred to as random walk method is a method allowing monitoring of the propagation of a cluster of particles, part of the motion of which is decided according to a probability law.

In this Lagrangian approach (particle motion monitoring), the displacement of a cluster of particles, dense enough to be statistically representative is followed. The motion of each particle is divided into a deterministic convective part and a stochastic diffusive part. When it impacts the wall, the particle is either consumed or reflected. In order to be precise and, unlike the usual stochastic process based on a consumption probability, the choice in a deterministic manner is made by calculating the reactive flow ₉ as a function of the concentration at the wall c_{w}.

φ=κ(c_{w}−c*)

After each time step, the moments are calculated from the coordinates rₙ of the particles:

$${m}_{i} ( t ) = {\sum }_{n} {r}_{n}^{i}$$

Over long times, the moments tend towards linear asymptotes whose slopes are equal to the asymptotic values of the desired macroscopic coefficients.

The random walk method is a robust process since it is based on simple and well-known physical laws. Besides, this method can be readily applied to geometries for which there is no analytical solution.

However, its main drawback lies in its high CPU time requirement. Thus, in order to reduce the number of particles involved without cutting down on the precision of the results, it is possible, according to another embodiment, to reinject the consumed particles without disturbing the concentration profile. In practice, the number of particles just has to be duplicated when fifty per cent of the initial particles have already reacted at the wall.

According to another embodiment, these calculations of spatial moments of the solute are carried out during a preliminary stage, only once for each geometry. At the pore scale, the transport proportionality coefficients v̅′, D̅′ and γ̅′ only depend on the geometry and on the Péclet-Damköhler number. This number is denoted by PeDa. For each geometry, they can thus be expressed once and for all as a function of PeDa. These laws are then communicated to the PNM network model as input data. PeDa then just has to be calculated during the simulation in order to obtain the proportionality coefficients and to be able to solve the reactive transport. These correctives are physically determined, once, by means of the spatial moments of the solute.

In order to explore all of the reactive regimes, the previous method has to be repeated several times (one point per Péclet-Damköhler number). Then, in order to facilitate the implementation of these laws in the pore network model, the transport proportionality coefficients are expressed by analytical functions whose generic formulation is as follows:

$$f ( PeDa ) = 1 + \frac{a}{{( 1 + \frac{b}{{( PeDa )}^{α}} )}^{β}} where$$

$$f = {\overline{γ}}^{′} or {\overline{v}}^{′} or {\overline{D}}^{′}$$

Parameter a describes the behavior of the proportionality coefficient with high PeDa numbers, that is, when the diffusive transport towards the wall is limiting with regard to the intrinsic reaction kinetics. The first term of the sum expresses the behavior for low PeDa numbers, that is when the surface reaction limits the kinetics. Tending in this case towards the conventional transport conditions, this term is equal to 1.

$${lim}_{PeDa -> 0} f = 1 and a = {lim}_{PeDa -> ∞} f - 1$$

Parameter b is associated with the critical Péclet-Damköhler number PeDa_{c} that separates the two aforementioned behaviors. The rapidity of transition between these two regimes is controlled by superscripts α and β. The first one controls the slope in the neighbourhood of PeDa_{c} and the second one governs the curvature.

The characteristic length involved in PeDa_{c} is equal to the inscribed radius of the capillary tube:

$$PeDa = \frac{κ R}{D}$$

where:

κ is the intrinsic reaction velocity;

R is the inscribed radius of the capillary; and

D is the molecular diffusion coefficient.

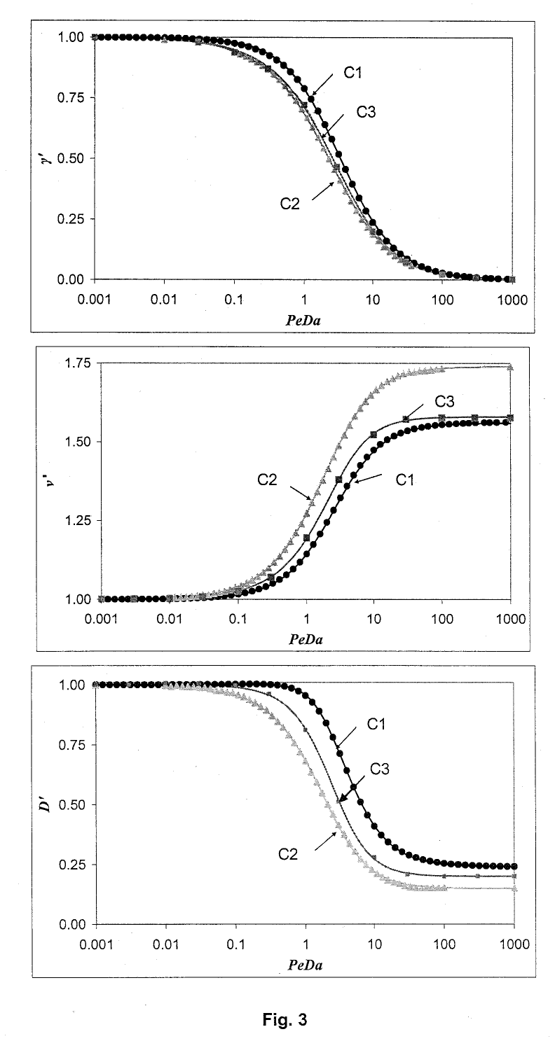

Below are the values of the parameters of the function for expressing the transport proportionality coefficients for three geometries: the cylinder with a circular base (C1), an equilateral triangular base (C2) and an elliptical base (C3), the ratio between the large and the small axis being 2. The graphical representations of these functions are shown in FIG. 3.

| | | a | b | □ | β |
|---|---|---|---|---|---|
| C1 | γ̅′ | −1.00 | 2.92 | 1.02 | 1.13 |
| | ν̅′ | 0.56 | 3.67 | 1.22 | 0.88 |
| | D̅′ | −0.76 | 1.64 | 1.26 | 2.98 |
| C2 | γ̅′ | −1.00 | 3.14 | 1.02 | 0.81 |
| | ν̅′ | 0.74 | 2.59 | 1.19 | 0.78 |
| | D̅′ | −0.85 | 3.48 | 1.40 | 0.66 |
| C3 | γ̅′ | −1.00 | 3.92 | 1.05 | 0.78 |
| | ν̅′ | 0.58 | 5.06 | 1.47 | 0.61 |
| | D̅′ | −0.80 | 5.63 | 1.64 | 0.78 |

c. Solving the Pore-Scale Reactive Transport Equation

Once these coefficients are determined, the pore-scale concentration field c̅ can be solved numerically. A parallel can be drawn with the solution of the pressure field from the hydraulic conductances of the constituent elements of the network, deduced from Poiseuille's law. The asymptotic solution to the system is precisely desired for which the concentration field relaxes uniformly towards equilibrium in the absence of external perturbations (periodic network).

This task is a primordial stake since its precision partly influences the precision of all the others. Within the pore network approach, the pore-scale information is implicitly taken into account via effective parameters: the hydraulic conductances for the flow and the proportionality coefficients for the reactive transport. These parameters are calculated for each unit cell of the PNM network. The data required are the shape of the section and the Péclet-Damköhler number. Then, using function f presented in the previous stage, the proportionality coefficients are directly (and physically) obtained. The hydraulic conductances are estimated according to Poiseuille's law.

The next stage then determines the mean concentration profile between two pores. The macroscopic transport equation, which is a second-order differential equation in asymptotic regime, is therefore analytically solved at the pore network scale:

$$\frac{\partial \overline{c}}{\partial t} + ∇ \cdot ( {\overline{v}}^{′} \overline{v} \overline{c} - {\overline{D}}^{′} \overline{D} \cdot ∇ \overline{c} ) + {\overline{γ}}^{′} \overline{γ} \cdot ( \overline{c} - {c}^{*} ) = 0$$

The boundary conditions of this system are the concentrations of each pore of the network. The concentration at the node is numerically determined by writing the mass conservation: the sum of the net incoming flows has to be zero. The expression of these flows is deduced from the concentration profile solved between two nodes. Thus, the material flows are calculated by considering the convective and dispersive terms at the same time. This allows estimation of the flows with a precision that is unrivalled by the usual techniques, such as the upstream scheme for convection or the linear approximation for diffusion.

d. Determining the Transport Proportionality Coefficients at the Scale of the Reservoir Model Grid Cell

This stage determines the transport proportionality coefficients v̅′, D̅′ and γ̅′ at the pore network scale, that is at the scale of the cell of the reservoir model (one PNM model per cell). These coefficients are used by the reactive flow simulator (SER) to determine the concentrations in each cell of the reservoir model. A homogenization technique is then used.

Over long times (asymptotic regime), these coefficients are independent of time. They depend on the type of rock (topology, geometry), referred to as “rock type” and denoted by RT, and on the reactive flow regimes (Péclet and Péclet-Damköhler numbers).

As for stage b, the asymptotic values of the proportionality coefficients are determined by the first three spatial moments of the solute. Those of the pore network, denoted by Mᵢ, are calculated from moments mᵢ of each unit cell of the PNM model, according to the following formulas:

$${M}_{0} = {\int }_{net} c d {r}^{3} = {\sum }_{n} {m}_{0} ( n )$$

$${M}_{1} = {\int }_{net} cR d {r}^{3} = {\sum }_{n} {m}_{0} ( n ) \cdot {\overline{R}}_{n} + {\sum }_{n} {m}_{1} ( n )$$

$$\begin{matrix}{M}_{2} = {\int }_{net} {cR}^{2} d {r}^{3} \\ = {\sum }_{n} {m}_{0} ( n ) \cdot {\overline{R}}_{n}^{2} + 2 {\sum }_{n} sym ( {\overline{R}}_{n} {m}_{1} ( n ) ) + {\sum }_{n} {m}_{2} ( n )\end{matrix}$$

with R the macroscopic position such that:

R= R̅ₙ+r

where:
R̅ₙ is the position, in the network reference frame, of the centre of the unit cell, and
r is the local position within the unit cell.

Moments mᵢ are obtained analytically by integrating the longitudinal concentration profile between two nodes (z being the length measured from a node), as mentioned in the previous stage.

mᵢ(t)=∫ c̅(z,t)zⁱdz

After normalizing the macroscopic coefficients v̅′, D̅′ and γ̅′ by the apparent reaction velocity obtained in the case of a perfect mix, the mean interstitial velocity and the molecular diffusion coefficient, respectively, the following expressions for the transport proportionality coefficients are obtained:

$${\overline{\overline{γ}}}^{′} = \frac{{\overline{\overline{γ}}}^{*}}{\overline{\overline{γ}}} = \frac{1}{{M}_{0}} {\sum }_{n} {m}_{0} ( n ) \cdot \frac{{\overline{σ}}_{n}}{\overline{\overline{σ}}} \cdot {\overline{γ}}_{n}^{′}$$

$${\overline{\overline{v}}}^{′} = \frac{1}{{M}_{0}} {\sum }_{n} {m}_{0} ( n ) {\overline{v}}_{n}^{′} \frac{{\overline{v}}_{n}}{\overline{\overline{v}}} - \frac{\overline{\overline{σ}}}{{M}_{0}} \frac{\overline{PeDa}}{\overline{Pe}} \cdot {\sum }_{n}^{N} ( {\overline{γ}}_{n}^{′} \cdot \frac{{\overline{σ}}_{n}}{\overline{\overline{σ}}} - {\overline{\overline{γ}}}^{′} ) ( {m}_{0} ( n ) {\overline{R}}_{n} + {m}_{1} ( n ) )$$

$${\overline{\overline{D}}}^{′} = \frac{1}{{M}_{0}} {\sum }_{n} {m}_{0} ( n ) {\overline{D}}_{n}^{′} + \frac{1}{{M}_{0}} \frac{\overline{Pe}}{l} {\sum }_{n} sym ( ( {\overline{v}}_{n}^{′} \cdot \frac{{\overline{v}}_{n}}{\overline{\overline{v}}} - {\overline{\overline{v}}}^{′} ) ( {m}_{0} ( n ) {\overline{R}}_{n} + {m}_{1} ( n ) ) ) - \frac{1}{2 {M}_{0}} \frac{\overline{\overline{σ}} \cdot \overline{PeDa}}{l} {\sum }_{n} ( {\overline{γ}}_{n}^{′} \cdot \frac{{\overline{σ}}_{n}}{\overline{\overline{σ}}} - {\overline{\overline{γ}}}^{′} ) ( {m}_{0} ( n ) {\overline{R}}_{n}^{2} + 2 sym ( {\overline{R}}_{n} {m}_{1} ( n ) ) + {m}_{2} ( n ) )$$

with:

γ̅=κ σ̅ and γ̅ₙ=k σ̅ₙ

2·sym(AB)=AB+BA

where:

σ is the reactive specific surface area;

l is a length characteristic of the transport;

P̅e̅ is the Péclet number, which describes the flow regime; and

P̅e̅D̅a̅ is the Péclet-Damköhler number, which governs the reactive regime.

$$\overline{Pe} = \frac{\overline{v} \cdot l}{D} and \overline{PeDa} = \frac{κ l}{D}$$

The Péclet number (Pe) compares the diffusive and convective characteristic times, and the Péclet-Damköhler number (PeDa) is the ratio between the diffusion and reaction characteristic times. The detailed role of these numbers is explained in the following paper:
BEKRI S., THOVERT J. F. et ADLER P. M., Dissolution of Porous Media, Chemical Engineering Science, 1995, 50, n° 17, p. 2765-2791.

For each rock type (RT), these formulas can be evaluated numerically by the PNM pore network model and optionally expressed by analytical functions as described in stage b. They are then integrated in the reactive flow simulator (SER) in order to improve the representativity and the predictability of the simulations carried out at this scale (FIG. 2b).

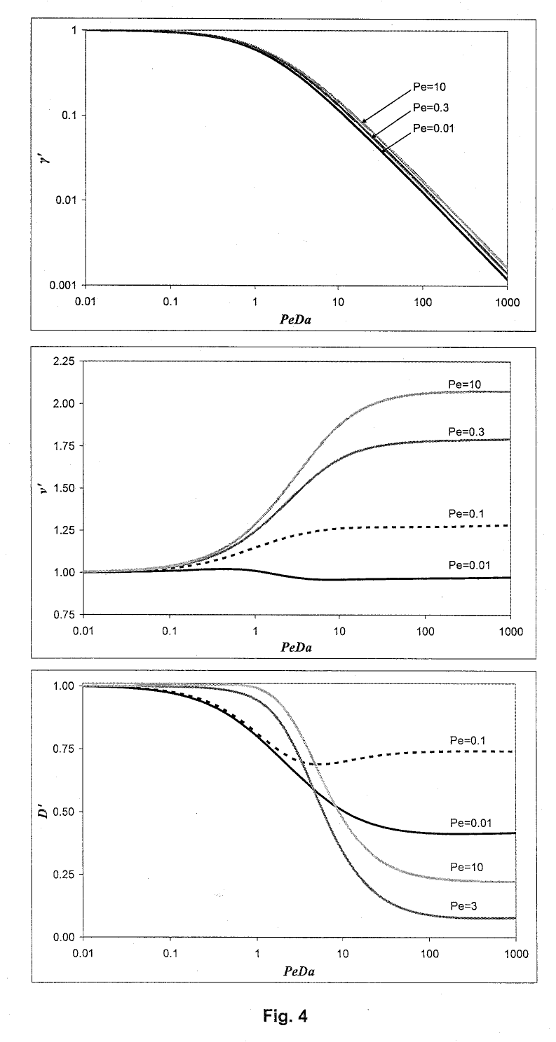

By way of illustration, FIG. 4 plots the three transport proportionality coefficients versus PeDa for various flows. These curves have been obtained for a uniform pore size distribution. It can for example be observed that, when the flow is slow, the mean velocity of the solute is approximately twice as high as that of the fluid in cases where the reaction is intense, and that the dispersion is then four times lower. This shows how important it is to evaluate precisely and physically the proportionality coefficients in order to have reliable simulations.

Structural Modifications and Evolution of the Petrophysical Properties (K-φ)

Within the context of reactive transport, the precision of the evolution of a property depends on two factors:
The first one which is extrinsic, is the knowledge of the chemical imbalance at the origin of this evolution. A better simulation of the transport of the chemical species generating this imbalance can disrupt the expected scenario. Thus, the zone impacted by the reactive fluid is larger than expected if the mean velocity of the solute is above the conventional estimations, and
the second one, which is intrinsic, is the prediction of the evolution of this property, caused by a given proportion of imbalance. It depends on whether the structure effects and the local specific features have been taken into account properly. For example, for a single mean imbalance, it is well known that the dissolution or precipitation phenomenon is more intense in the restrictions between pores than in the body of the pore.

From this observation, the simulations are improved by acting upon these two axes. The empirical relations initially introduced are replaced so as to, on the one hand, approximate the specific features of the reactive transport and, on the other hand, to estimate a permeability variation from a porosity variation, through relations based on the physics of reactive flows obtained using the pore network approach.

Thus, from the mean concentrations c̅ calculated in stage c, the concentrations at the wall c_{w} and the solute flow φ emitted or consumed are determined. It can be readily demonstrated that the chemical imbalance at the wall, normalized by the mean imbalance, is equal to the efficiency of the reaction γ̅′ of the unit cell. In fact, it is desirable to compare the expression of the source terms calculated either from the volume description (left-hand member of the equation below) or from the surface description (right-hand member):

γ̅*( c̅−c*)·V=κ(c_{w}−c*)·S

For a perfect mixer, γ̅*= γ̅ by definition, and c_{w}= c̅ because the concentration profile is uniform within a pore in this case. Therefore: γ̅=κσ with the specific surface area σ equal to SN.

According to the definition of efficiency γ̅′:

$${\overline{γ}}^{′} = \frac{{\overline{γ}}^{*}}{\overline{γ}} = \frac{{c}_{w} - {c}^{*}}{\overline{c} - {c}^{*}}$$

Consequently, the density of the local flow φ can be expressed by the mean chemical imbalance of the pore, obtained in stage c, of kinetics γ̅ calculated by a geochemical module and of efficiency γ̅′ determined in stage b:

φ=κ(c_{w}−c*)= γ̅· γ̅·( c̅−c*)

Knowing the stoichiometry s of the reaction, the molar mass M and the density ρ of the mineral, the thickness of the layer precipitated or dissolved during time step δt is calculated and, therefore, the evolution of the pore diameter. The thickness of the layer is a function of the reactive flow regime.

$$d ( t + δ t ) = d ( t ) + δ t \cdot s \frac{M}{ρ} ϕ$$

where d is the diameter of the body of the pore or of its restriction.

The evolution of the various petrophysical properties, including porosity and permeability, can then be deduced from the pore size distribution variation.

All that is necessary is to use the conventional pore network technique described for example in the following article:
S. Bekri, C. Laroche, O. Vizika, “Pore-Network Models to Calculate Transport Properties in Homogeneous and Heterogeneous Porous Media”. XIV International Conference on Computational Methods in Water Resources, 1115-1122, Jun. 23-28, 2002, Delft, The Netherlands.

Thus, permeability/porosity relations can be obtained for many reactive flow regimes and rock types. It is possible to approximate these relations by power laws or polynomial functions. As inputs in a reactive flow simulator, they can physically relate the porosity, calculated by the geochemical module, to the permeability.

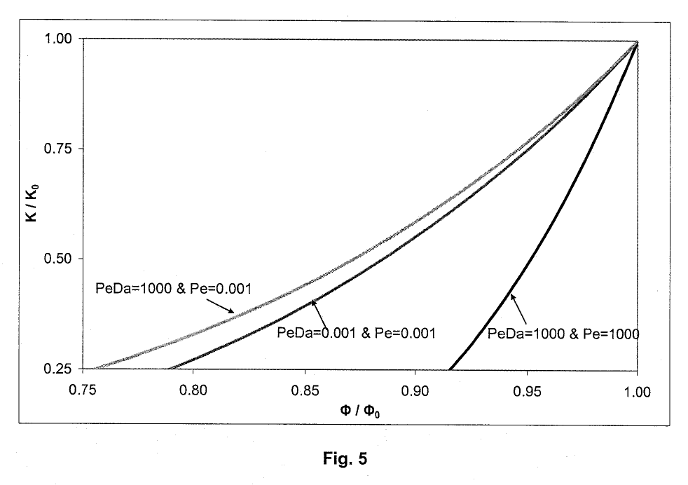

FIG. 5 shows permeability/porosity relations obtained for three reactive flow regimes, characterized by different Péclet and Péclet-Damköhler numbers. These three curves were plotted for the same rock type with a uniform 32-μm distribution with an aspect ratio equal to 4 and a specific surface area of 6 μm²/μm³. This highlights the impossibility of describing correctly the reactive phenomenon with a single empirical relation per rock type.

The method thus improves the predictions relative to the property modifications induced by a reactive fluid such as CO₂ at the scale of a reservoir. It concerns more particularly the evolution of the permeability, but the method can be applied to any other property.

Solving the Reactive Transport Equation at the Scale of the Reservoir Model Grid Cell

The permeability variation δK, the transport proportionality coefficients (CPT) and the mean apparent reaction velocity ( γ̅) are supplied to the reactive flow simulator (SER) in order to solve the transport equation. Knowing the permeability is in fact necessary to determine the velocity field at the next time iteration. The result is the mean concentration c̅ of the chemical species studied. This concentration is in turn used by the geochemical module (MG) via the coupling (CPL).

The method iterates, according to a time loop (BT), between these two modules and the PNM model. At the end of an iteration, the mean concentration c̅, a pore network structure updated according to the precipitations/dissolutions and a law K-φ are obtained in each cell of the reservoir model. All that is necessary is then just to reiterate with this new flow as many times as is desired.

4. Optimizing CO₂ Injection into the Porous Medium

The quality of the simulations allows determination of the concentration field which is invaluable for predicting possible injectivity losses, mechanical weakening, channelling creation and/or effects on cap rock integrity.

Depending on the result of these simulations, the decision to use or not use the reservoir considered for CO₂ storage is made. For example, if the simulations show too high a concentration around the surface, this indicates that the cap rock does not allow the CO₂ to be kept in the underground structure.

The amounts of CO₂ that can be injected and the optimum injection flow rate are also assessed. The development of the medium can also be modified by carrying out at least one of the following operations:
drilling new holes: if it is noted that part of the reservoir is not reached by the CO₂, a well reaching this part can be drilled so as to store more CO₂′
modifying the injection pressure if it is noted that the CO₂ has difficulty migrating within the reservoir;
setting a remediation device: if it is noted a leak (occurs by detecting high concentrations outside the reservoir), plugged systems or any other known remediation systems can be used;
adding additives to the CO₂ with known additives for facilitating its migration within the reservoir can for example be added.

Advantages

The invention allows increasing the quality of reactive flow simulations in porous media, which is essential in the context of CO₂ injection, whether for its geological storage or to improve hydrocarbon recovery.

As illustrated in FIGS. 2a and 2b, the empirical laws independent of the reactive transport regime are replaced in the invention by laws depending on the non-dimensional numbers that govern it (Pe and PeDa). The coupling between transport and geochemistry still remains, but it is indirect here, because transport is a function of the “real” source term, that is accounting for the structure and of the limitations due to the mass transfer. The law relating porosity to permeability is no longer a single law, it is a function of the reactive flow.

The invention thus permits modelling simulation of the specific features of reactive transport by a pore network approach using macroscopic transport equation modifications via the addition of adequate proportionality coefficients and evolution of the petrophysical properties due to induced structural modifications.

1-11. (canceled)

12. A method of optimizing injection of a fluid into a porous medium including a pore network in which data relative to the porous medium and relative to the fluid are acquired, a discretization of the porous medium is constructed in a set of grid cells and a migration of the fluid within the porous medium is modelled by a computer by determining in each grid cell a concentration of a chemical species involved in a chemical reaction between the fluid and the medium, by solving a reactive transport equation at a scale of a cell, comprising:
determining in each grid cell the concentration of the chemical species by solving with a computer programmed with software to solve the reactive transport equation by accounting for modifications in the concentration of the chemical species at a scale of a pore in the pore network by representation of the pore network for each cell by a pore network model (PNM model); and
optimizing the injection of the fluid into the porous medium, as a function of the concentrations in each cell.

13. A method as claimed in claim 12, wherein pore-scale concentration modifications are accounted for by modifying structurally the PNM model in each cell.

14. A method as claimed in claim 12, wherein the reactive transport equation is solved by carrying out the following:
i. constructing a representation of the pore network for each cell with the PNM model comprising a set of nodes of known geometry connected by channels of known geometry;
ii. defining the scale of the reactive transport equation by relating the concentration c̅ to a mean velocity of the species v̅, a mean dispersive tensor of the species D̅ and a mean reaction apparent velocity on a cell γ̅′, and wherein one of the parameters are weighted by transport proportionality coefficients v̅′, D̅′ and γ̅′ at the scale of the cell;
iii. determining the coefficients v̅′ , D̅′ and γ̅′ by the PNM model;
iv. accounting for structural modifications of the pore network generated by a chemical reaction, by modifying the PNM model and by determining petrophysical properties from the modified PNM model; and
v. solving the reactive transport equation from the coefficients v̅′, D̅′ and γ̅′, the petrophysical properties, and measurements relative to the medium and to the fluid.

15. A method as claimed in claim 14, wherein the reactive transport equation is solved by carrying out the following:
i. constructing a representation of the pore network for each cell with a PNM model comprising a set of nodes of known geometry connected by channels of known geometry;
ii. defining the scale of the reactive transport equation by relating the concentration c̅ to a mean velocity of the species v̅, a mean dispersive tensor of the species D̅ and a mean reaction apparent velocity on a cell γ̅, and wherein one of the parameters are weighted by a cell-scale transport proportionality coefficients v̅′, D̅′ and γ̅′ at the scale of the cell;
iii. determining the coefficients v̅′, D̅′ and γ̅′ by the PNM model;
iv. accounting for structural modifications of the pore network generated by a chemical reaction, by modifying the PNM model and by determining petrophysical properties from the modified PNM model; and
v. solving the reactive transport equation from the coefficients v̅′, D̅′ and γ̅′, the petrophysical properties, and measurements relative to the medium and to the fluid.

16. A method as claimed in claim 14, wherein the proportionality coefficients v̅′, D̅′ and γ̅′ are determined by the following:
a. determining pore-scale transport proportionality coefficients v̅′, D̅′ and γ̅′ in each channel and node of the PNM model;
b. determining a concentration of the species in each channel and node of the PNM model by solving the reactive transport equation at the scale of the pores from the transport proportionality coefficients v̅′, D̅′ and γ̅′; and
c. determining from results of a and b the cell-scale transport proportionality coefficients v̅′, D̅′ and γ̅′ by a homogenization method.

17. A method as claimed in claim 15, wherein the proportionality coefficients v̅′, D̅′ and γ̅′ are determined by the following:
a. determining pore-scale transport proportionality coefficients v̅′, D̅′ and γ̅′ in each channel and node of the PNM model;
b. determining a concentration of the species in each channel and node of the PNM model by solving the reactive transport equation at the scale of the pores from the transport proportionality coefficients v̅′, D̅′ and γ̅′; and
c. determining from results of a and b the cell-scale transport proportionality coefficients v̅′, D̅′ and γ̅′ by a homogenization method.

18. A method as claimed in claim 14, wherein the reactive transport equation at the scale of the cells is:
$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$
where c* is an equilibrium concentration of the species.

19. A method as claimed in claim 15, wherein the reactive transport equation at the scale of the cells is:
$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$
where c* is an equilibrium concentration of the species.

20. A method as claimed in claim 16, wherein the reactive transport equation at the scale of the cells is:
$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$
where c* is an equilibrium concentration of the species.

21. A method as claimed in claim 17, wherein the reactive transport equation at the scale of the cells is:
$$\frac{\partial \overline{\overline{c}}}{\partial t} + ∇ \cdot ( {\overline{\overline{v}}}^{′} \overline{\overline{v}} \cdot \overline{\overline{c}} - {\overline{\overline{D}}}^{′} \overline{\overline{D}} \cdot ∇ \overline{\overline{c}} ) + {\overline{\overline{γ}}}^{′} \overline{\overline{γ}} \cdot ( \overline{\overline{c}} - {c}^{*} ) = 0$$
where c* is an equilibrium concentration of the species.

22. A method as claimed in claim 16, wherein the transport proportionality coefficients v̅′, D̅′ and γ̅′ defined as a function of spatial moments of the species.

23. A method as claimed in claim 20, wherein the transport proportionality coefficients v̅′, D̅′ and γ̅′ are defined as a function of spatial moments of said species.

24. A method as claimed in claim 22, wherein the transport proportionality coefficients v̅′, D̅′ and γ̅′ are determined from spatial moments of the species or a random walk method.

25. A method as claimed in claim 23, wherein the transport proportionality coefficients v̅′, D̅′ and γ̅′ are determined from spatial moments of the species or a random walk method.

26. A method as claimed in claim 22, wherein the pore-scale transport proportionality coefficients v̅′, D̅′ and γ̅′ are defined as:
$$f ( PeDa ) = 1 + \frac{a}{{( 1 + \frac{b}{{( PeDa )}^{α}} )}^{β}}$$
and where
f= γ̅′ or v̅′ or D̅′
PeDa is the Péclet-Damköhler number, and a, b, α and β are parameters defined as a function of the geometry of the PNM model.

27. A method as claimed in claim 23, wherein the pore-scale transport proportionality coefficients v̅′, D̅′ and γ̅′ are defined as:
$$f ( PeDa ) = 1 + \frac{a}{{( 1 + \frac{b}{{( PeDa )}^{α}} )}^{β}}$$
and where
t= γ̅′ or v̅′ or D̅′
PeDa is the Péclet-Damköhler number, and a, b, α and β are parameters defined as a function of the geometry of the PNM model.

28. A method as claimed in claim 14, wherein the PNM model is modified to account for structural modifications of the pore network generated through chemical reaction by determining a concentration of the chemical species at walls of each node and each channel and determining therefrom a variation in the geometry of the nodes and channels of the PNM model.

29. A method as claimed in claim 15, wherein the PNM model is modified to account for structural modifications of the pore network generated through chemical reaction by determining a concentration of the chemical species at walls of each node and each channel and by determining therefrom a variation in the geometry of the nodes and channels of the PNM model.

30. A method as claimed in claim 16, wherein the PNM model is modified to account for structural modifications of the pore network generated through chemical reaction by determining a concentration of the chemical species at walls of each node and each channel and by determining therefrom a variation in the geometry of the nodes and channels of the PNM model.

31. A method as claimed in claim 17 wherein the PNM model is modified to account for structural modifications of the pore network generated through chemical reaction by determining a concentration of the chemical species at walls of each node and each channel and by determining therefrom a variation in the geometry of the nodes and channels of the PNM model.

32. A method as claimed in claim 18 wherein the PNM model is modified to account for structural modifications of the pore network generated through chemical reaction by determining a concentration of the chemical species at walls of each node and each channel and by determining therefrom a variation in the geometry of the nodes and channels of the PNM model.

33. A method as claimed in claim 19 wherein the PNM model is modified to account for structural modifications of the pore network generated through chemical reaction by determining a concentration of the chemical species at walls of each node and each channel and by determining therefrom a variation in the geometry of the nodes and channels of the PNM model.

34. A method as claimed in claim 20 wherein the PNM model is modified to account for structural modifications of the pore network generated through chemical reaction by determining a concentration of the chemical species at walls of each node and each channel and by determining therefrom a variation in the geometry of the nodes and channels of the PNM model.

35. A method as claimed in claim 21 herein the PNM model is modified to account for structural modifications of the pore network generated through chemical reaction by determining a concentration of the chemical species at walls of each node and each channel and by determining therefrom a variation in the geometry of the nodes and channels of the PNM model.

36. A method as claimed in claim 22 wherein the PNM model is modified to account for structural modifications of the pore network generated through chemical reaction by determining a concentration of the chemical species at walls of each node and each channel and by determining therefrom a variation in the geometry of the nodes and channels of the PNM model.

37. A method as claimed in claim 23 wherein the PNM model is modified to account for structural modifications of the pore network generated through chemical reaction by determining a concentration of the chemical species at walls of each node and each channel and by determining therefrom a variation in the geometry of the nodes and channels of the PNM model.

38. A method as claimed in claim 24, wherein the PNM model is modified to account for structural modifications of the pore network generated through chemical reaction by determining a concentration of the chemical species at walls of each node and each channel and by determining therefrom a variation in the geometry of the nodes and channels of the PNM model.

39. A method as claimed in claim 25, wherein the PNM model is modified to account for structural modifications of the pore network generated through chemical reaction by determining a concentration of the chemical species at walls of each node and each channel and by determining therefrom a variation in the geometry of the nodes and channels of the PNM model.

40. A method as claimed in claim 26, wherein the PNM model is modified to account for structural modifications of the pore network generated through chemical reaction by determining a concentration of the chemical species at walls of each node and each channel and by determining therefrom a variation in the geometry of the nodes and channels of the PNM model.

41. A method as claimed in claim 27, wherein the PNM model is modified to account for structural modifications of the pore network generated through chemical reaction by determining a concentration of the chemical species at walls of each node and each channel and by determining therefrom a variation in the geometry of the nodes and channels of the PNM model.

42. A method as claimed in claim 14, wherein the measurements comprise at least:
measurements relative to the fluid including a molecular diffusion coefficient, density and viscosity; and
measurements relative to the medium including permeability, porosity, lithological facies, density and intrinsic reaction velocity.

43. A method as claimed in claim 14, wherein the fluid is CO₂, and CO₂ is injected into the porous medium which is optimized by at least one of the operations:
modifying an amount of CO₂ injected into the medium;
modifying a CO₂ injection flow rate;
drilling new holes in the medium to inject the CO₂;
setting at least one remediation device in the medium to remedy CO₂ leaking to the surface or into an aquifer; and
adding additives to the CO₂ which is injected.
